(19) United States
(12) Patent Application Publication
(10) Pub. No.: US 2016/0313093 A1
(43) Pub. Date: Oct. 27, 2016

(54) FLUID ENCAPSULATED FLOORING SYSTEM

(71) Applicants: Gregory Hiemenz, Silver Spring, MD (US); Pablo Sztein, Silver Spring, MD (US)

(72) Inventors: Gregory Hiemenz, Silver Spring, MD (US); Pablo Sztein, Silver Spring, MD (US)

(21) Appl. No.: 14/940,758

(22) Filed: Nov. 13, 2015

Related U.S. Application Data
(60) Provisional application No. 62/078,568, filed on Nov. 12, 2014.

(51) Int. Cl. F41H 7/04; B62D 21/15

(52) U.S. Cl. CPC F41H 7/042; B62D 21/15

(57) ABSTRACT

The present invention relates to a system for attenuating loads transmitted from a base to a supported payload, and more particularly to a system utilizing a plurality of chambers of encapsulated fluid sandwiched between a base and payload interface for providing said attenuation.

### CROSS-REFERENCE TO RELATED APPLICATION(S)

The present application derives priority from U.S. provisional application Ser. No. 62/078,568 filed Nov. 12, 2014.

### BACKGROUND OF THE INVENTION

1. Field of the invention

The present invention relates to a system for attenuating loads transmitted from a base to a supported payload.

2. Description of the Background

The defining weapon in recent military conflicts has been the constantly evolving Improvised Explosive Device (IED). Underbody blasts to vehicles from IEDs lead to significant loading to the lower limbs and spine of occupants, resulting in devastating injuries. While energy absorption (EA) devices have been employed to protect the soldier's pelvis, spine and upper body during an underbody blast event, few effective and practical EA technologies have been developed to protect the lower extremities. Energy absorbing flooring systems offer the potential for protecting both the occupant legs and spine (assuming a floor mounted seat), but little investment has been made in these to-date. A key reason for a lack of EA flooring technologies is that conventional EA technologies rely on plastic deformation of materials to provide the energy attenuating force-stroke profile. As such, designs are: 1) heavy, 2) not tunable/adaptable to address varying floor loading, 3) complex to manufacture and thus high cost, and 4) cannot provide protection to occupants during both initial blast and resulting slam-down impact without being impractically thick. As a result, there remains a need for a simple, lightweight, tunable, and efficient EA flooring system to reduce occupant injury. EA flooring utilizing encapsulated fluid such as air or other low density fluids has the potential to lead to not only provide improved soldier protection, but also lighter vehicles, enhanced mobility, as well as reduction in manufacturing and sustainment costs.

The use of EA flooring, however, is not limited to vehicle underbody blasts nor occupant protection. There are several other use cases for such a system, both vehicular and non-vehicular, including but not limited to attenuation of crash loads, shock and vibration during transit, seismic loading, etc. Protected payloads may be people/animals, structures, equipment, etc.

### SUMMARY OF THE INVENTION

The present invention includes a system for attenuating load transferred from a base to a supported payload using encapsulated fluid.

The first aspect of the invention is a system with a plurality of fluid encapsulated chambers sandwiched between a base and a payload interface.

The second aspect of the invention is a system where one or more of said chambers vent to reduce load transmitted from base to payload interface.

A third aspect of the invention is a system where said venting initiates upon a dynamic parameter, including but not limited to pressure, acceleration, time, velocity, displacement, rotation, force, and moment, reaching a pre-set threshold.

A fourth aspect of the invention is a system whereby the dynamic parameter exceeding said pre-set threshold causes a portion of said fluid chamber to become operatively decoupled to enable fluid flow out of the chamber.

A fifth aspect of the invention is a system whereby said plurality of chambers is made up of a set of primary and secondary chambers, with secondary chambers providing supplemental energy attenuating load at some point during the loading event.

A sixth aspect of the invention is a where said primary chambers are pressurized prior to loading event.

A seventh aspect of the invention is a system whereby loading event causes pressure in one or more chambers to increase.

An eighth aspect of the invention is a system whereby said fluid venting is to ambient or into another chamber.

A ninth aspect of the invention is a system whereby during or following the loading event, the vented fluid is replaced by an external source.

A tenth aspect of the invention is a system whereby vent area, pre-set inflation pressure, and pre-set vent trigger thresholds are tailored for severity of loading event and supported payload.

An eleventh aspect of the invention includes a system whereby said chambers vent independently to minimize dynamic deformation of the payload interface.

A twelfth aspect of the invention includes a system whereby said chamber(s) are designed such that the cross sectional area of the chambers vary (or not) along the stroking direction to provide a desirable load-stroke profile. For example, cross-sectional area may be designed to be substantially constant in stroking direction to provide a substantially constant load-stoke profile or tapered to yield an increasing or decreasing load-stroke profile.

A thirteenth aspect of the invention includes a system whereby said payload interface is mechanically constrained to the base in at least one degree of freedom via mechanisms including but not limited to linear bearings, sliders, pivots, bolts through clearance holes, and the like.

A fourteenth aspect of the invention includes a plurality of independently acting systems position adjacently such that the aggregated payload interfaces yield an appearance of a continuous surface or floor.

A fifteenth aspect of the invention is a plurality of independently acting systems whereby each system is independently tuned for the payload that it supports.

### BRIEF DESCRIPTION OF THE DRAWINGS

Other objects, features, and advantages of the present invention become more apparent from the following detailed description of the preferred embodiments and certain modifications thereof when taken together with the accompanying drawings in which:

FIG. 1 is a block diagram of an embodiment of the fluid-encapsulated flooring system 2 of the invention.

FIG. 2 illustrates a first valve 10/chamber 4 arrangement suitable for use in the embodiment of FIG. 1.

FIG. 3 illustrates a second valve 10/chamber 4 arrangement suitable for use in the embodiment of FIG. 1.

FIG. 4 is a conceptual diagram illustrating how independently venting fluid chambers 4 minimizes payload interface (top plate) 8 deformation within a minimum stroke length of the bottom plate 6.

FIG. 5 illustrates a mathematical model of the invention.

FIG. 6 illustrates a potential input (base plate acceleration) and output (top plate acceleration) of the invention.

FIG. 7 and FIG. 8 depict a modular tile-embodiment of the present invention in which a plurality of such systems 20 are positioned in a tile pattern.

FIG. 9 shows two options for mechanically constraining the payload interface 8 with respect to the base 6 in at least one degree of freedom.

FIG. 10 shows another embodiment of a tiled energy absorbing flooring unit 40 similar to that of FIG. 8 except that the four primary chambers 44A are tapered to illustrate how varying the cross-sectional area of a chamber yields an increasing or decreasing load-stroke profile.

### DETAILED DESCRIPTION OF THE INVENTION

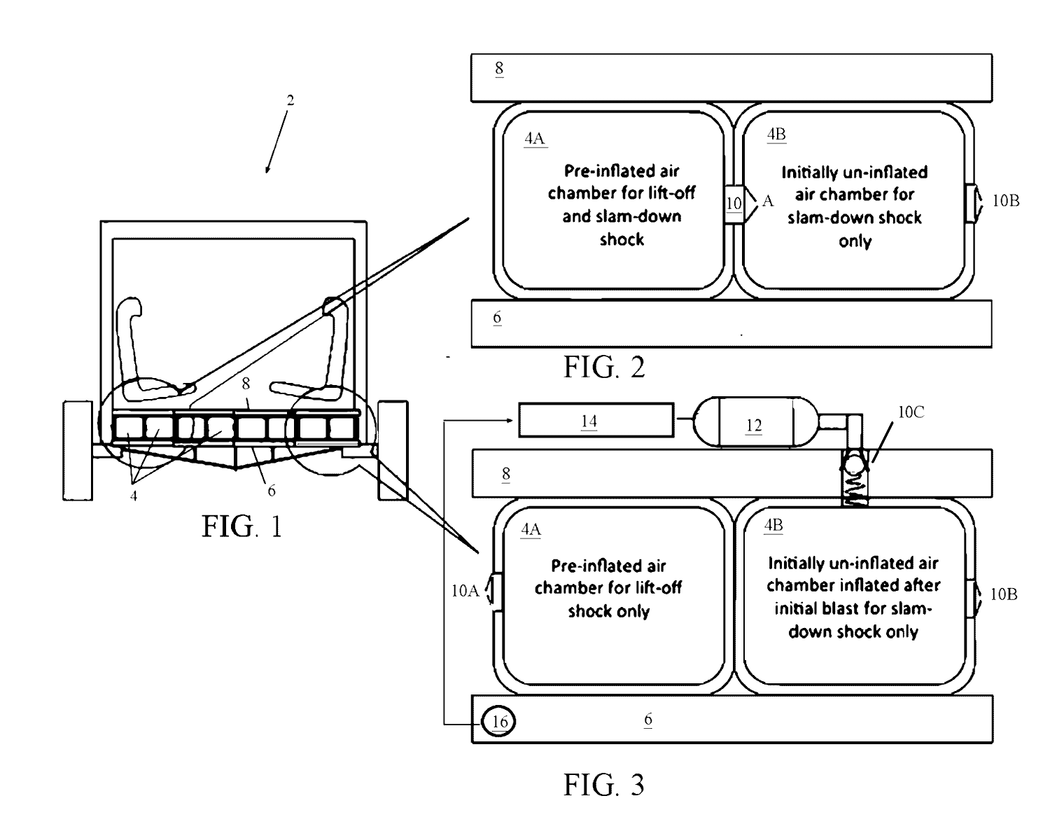

FIG. 1 depicts an embodiment of the fluid-encapsulated flooring system 2 of the invention used as vehicular flooring. The flooring system 2 generally includes a plurality of fluid chambers 4 sandwiched between a base plate 6 and an independent top plate (the “payload interface 8”). The fluid chambers 4 are inflatable, and may comprise either primary chambers (pre-inflated) or secondary (initially uninflated) chambers. The fluid-encapsulated flooring system 2 employs a sequence of valves 10 (See FIGS. 2-3) for venting and/or inflation, and the particular valve 10 (See FIGS. 2-3) and primary/secondary chamber 4 arrangements may vary slightly depending on the mode of operation.

For purposes of this description, “valve” shall mean any type of valve or orifice used to control fluid flow rate, including but not limited to a simple fixed orifice; a variable orifice; a flow regulator valve, a bypass flow regulator; a demand-compensated flow control valve; a pressure-compensated, variable flow valve; a pressure-compensated, variable flow-control valve (adjusts to varying inlet and load pressures); a pressure- and temperature-compensated, variable flow-control valve (adjusts the orifice size to offset changes in fluid viscosity); a priority valve (supplies fluid at a set rate); or a deceleration valve (slows load by being gradually closed).

The terms “chamber”, “fluid chamber”, “air chamber” and/or “sac” mean any hollow, flexible structure including a bag or pouch, defined by a cavity enclosed by collapsible walls or a membrane.

FIG. 2 illustrates a first valve 10/chamber 4 arrangement in which each pair of adjacent chambers 4 includes one primary chamber 4A and one secondary chamber 4B. One or more valves 10A are installed between each pair of adjacent chambers 4 leading from primary chamber 4A to secondary chamber 4B. In addition, one or more valves 10B are installed leading from the secondary chamber 4B to ambient. Thus, in FIG. 2 the primary chambers 4A vent the fluid into the secondary chambers 4B, which, in turn vent to ambient. The primary chambers 4A are pre-inflated to a pressure greater than ambient.

FIG. 3 illustrates a second valve 10/chamber 4 arrangement in which each pair of adjacent chambers 4 includes one primary chamber 4A and one secondary chamber 4B. One or more valves 10A are installed leading from both the primary chamber 4A to ambient, and one or more valves 10B leading from the secondary chamber 4B to ambient (there are no inter-chamber valves). In FIG. 3 chamber 4B may be inflated during or after loading event by an external pressure source 12 (fluid/gas pump or generator) in fluid communication with chamber 4B through a third valve 10C. The pressure source 12 is activated by a processor 14 in response to one or more sensors 16 arranged to detect an impact. In operation, the primary chambers 4A are pre-inflated to a greater-than-ambient pressure. The secondary chambers 4B are initially uninflated, but upon detection of an impact event at sensor(s) 16 the secondary chambers 4B are inflated to a like pressure.

Trigger sensor(s) 16 could include; 1) accelerometers anywhere on the vehicle to trigger based on an acceleration threshold (5G, etc.); 2) break wire sensors mounted to the same locations as above or even between top and bottom plates 4, 8; 3) displacement sensor between top plate 8 and any nonstroking structure (subfloor, vehicle walls, hull, etc.). A displacement threshold could be some predetermined value of stroke (half inch, etc.); 4) pressure sensors measuring pressure of fluid chambers 4A, 4B that trigger based upon exceeding some percentage (e.g. 25%) of nominal (preinflated) pressure.

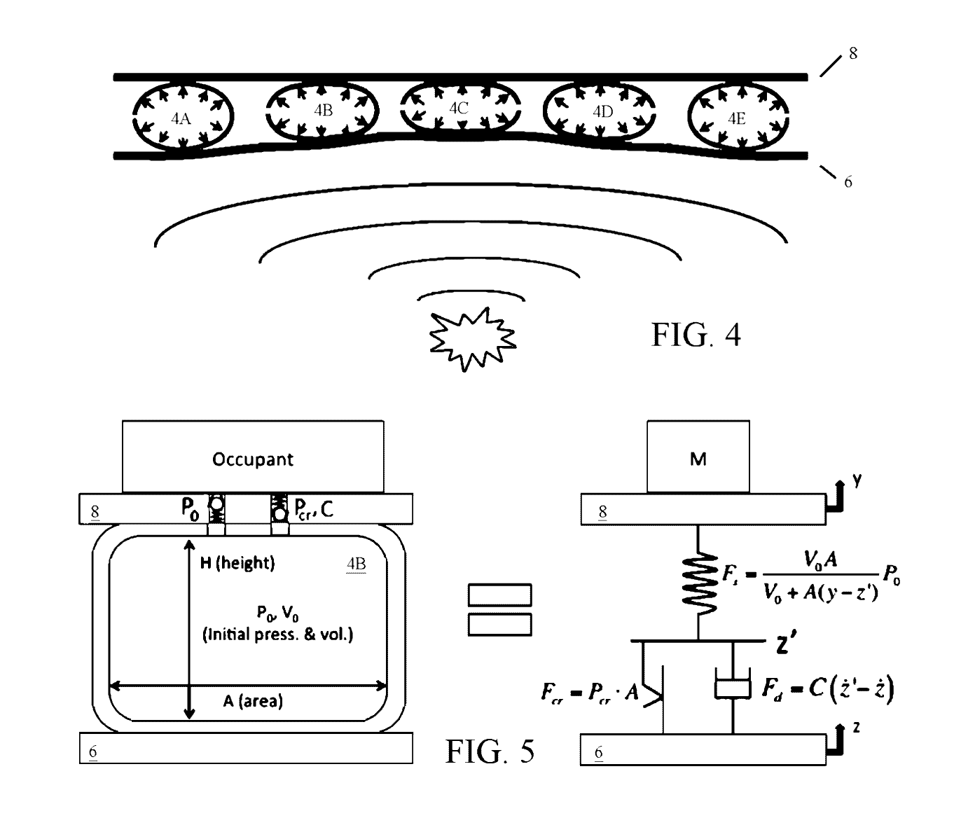

FIG. 4 depicts how independently venting fluid chambers can minimize payload interface (top plate) 8 deformation within a minimum stroke length of the bottom plate 6. This design goal requires a reduction in the peak acceleration at any given point along top plate 8 to thereby minimize impact to the payload mass (occupant legs, etc.). A broad attenuation of impact to protect the lower extremities of a full range of occupants not only serves the design goal, but also minimizes weight and cost, both important in a vehicular context. The configurations of FIG. 2 or FIG. 3 absorbs uneven blast energy imparted to bottom plate 6 and distributes it more evenly to the top plate.

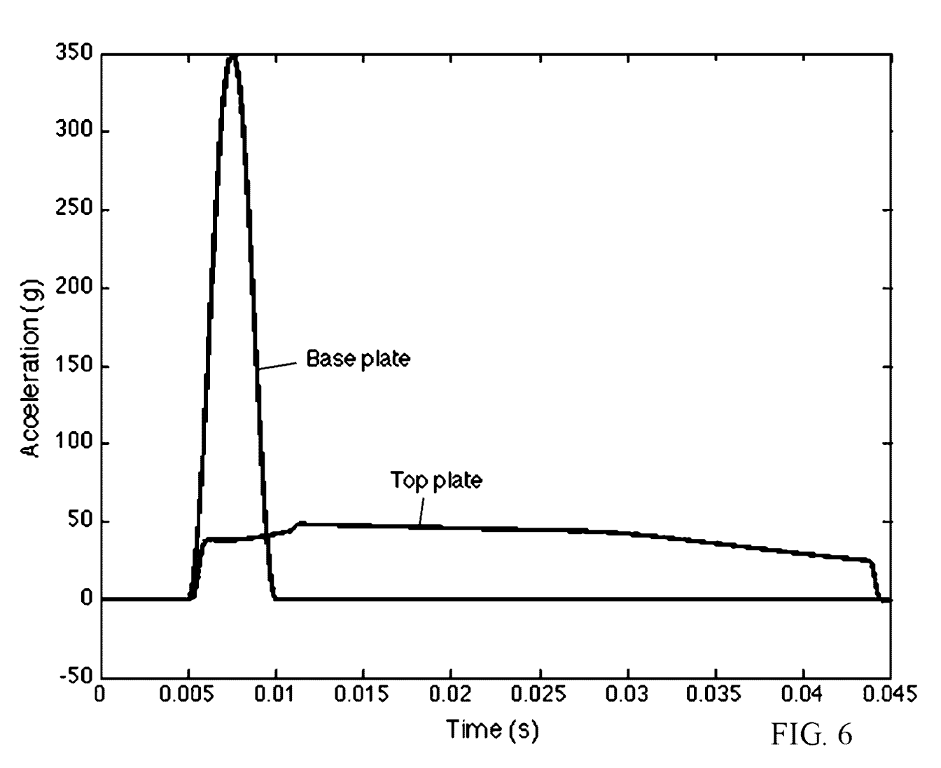

FIG. 5 shows how the system can be reduced to a mechanical mathematical model. As shown in FIG. 5 a single fluid chamber 4 is assumed in the mathematical representation. The initial pressure in the inflatable fluid chamber 4 is denoted as P₀, the vent pressure and damping coefficient of the valve are denoted as Pₑᵣ and C. The contact area of the fluid chamber 4 attached to the plates 6, 8 is A, and the initial internal volume and height of the fluid chamber are V₀ and H, respectively. The occupant mass placed on the top plate 8 can be denoted as M, and the mass quantity on top plate 8 can be determined based on the initial volume and pressure of the fluid chamber 4. Expanding upon this simplified model, a multi-degree-of-freedom leg mass model developed by Garg et al. (1976) was included in the lumped parameter model to consider biodynamic effects. In this model the lower extremities are represented using three lumped masses, i.e. foot/shoe, shank and thigh. In this analysis, a triangular vertical acceleration impulse with 350 g peak and 5 ms duration was applied to the base plate 6. With a prescribed pressure, i.e. P0=15 psi and Pₑᵣ=18 psi, the calculation of the lumped parameter model. The results are shown in FIG. 6.

FIG. 6 is a graphical depiction of sample input (base plate 6) and output accelerations (top plate 8) for the invention during operation. Clearly, the loading into the top plate 8 can be significantly attenuated.

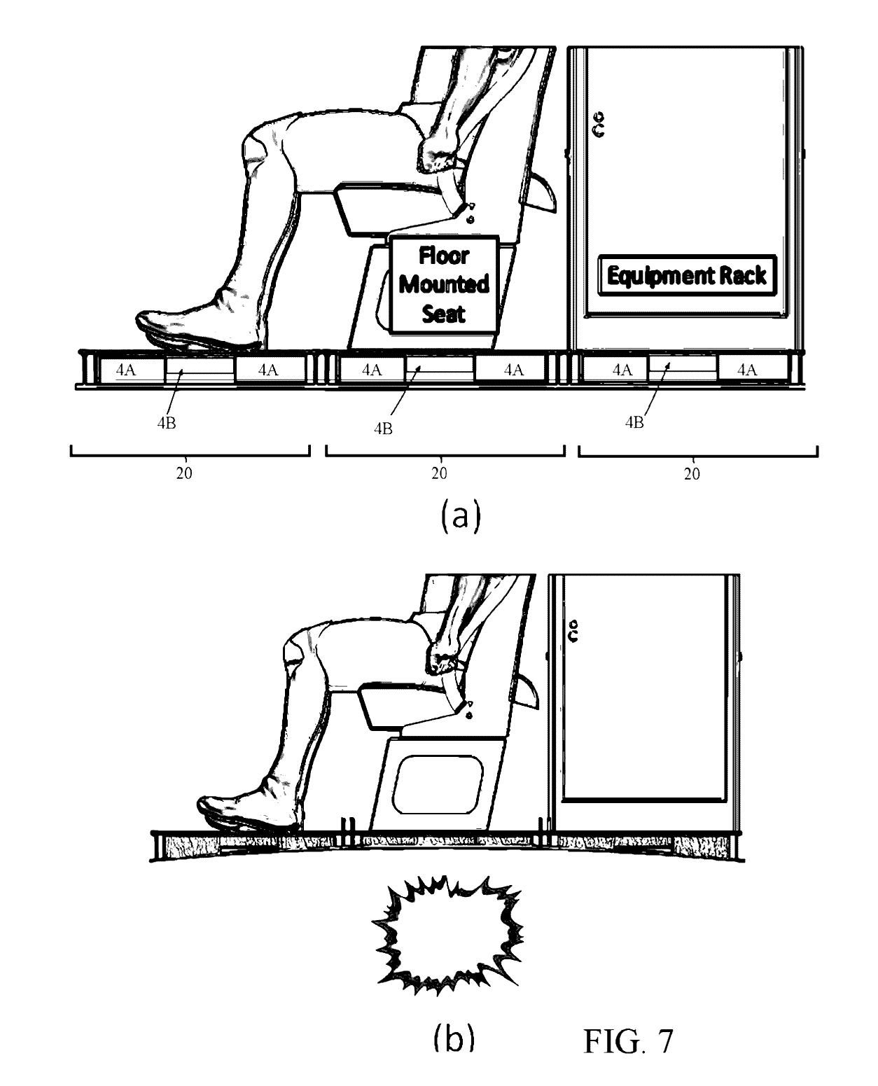

FIG. 7 depicts a modular embodiment of the present invention in which a plurality of energy absorbing flooring units 20 are positioned adjacently in a tiled pattern to give the collective result of the continuous embodiment of FIG. 1. The plurality of energy absorbing flooring units 20 may be positioned adjacently, and may be independently tuned to support varying payloads as shown (i.e., occupant feet, seat, equipment, etc.) both (a) prior to loading event, and (b) during a loading event.

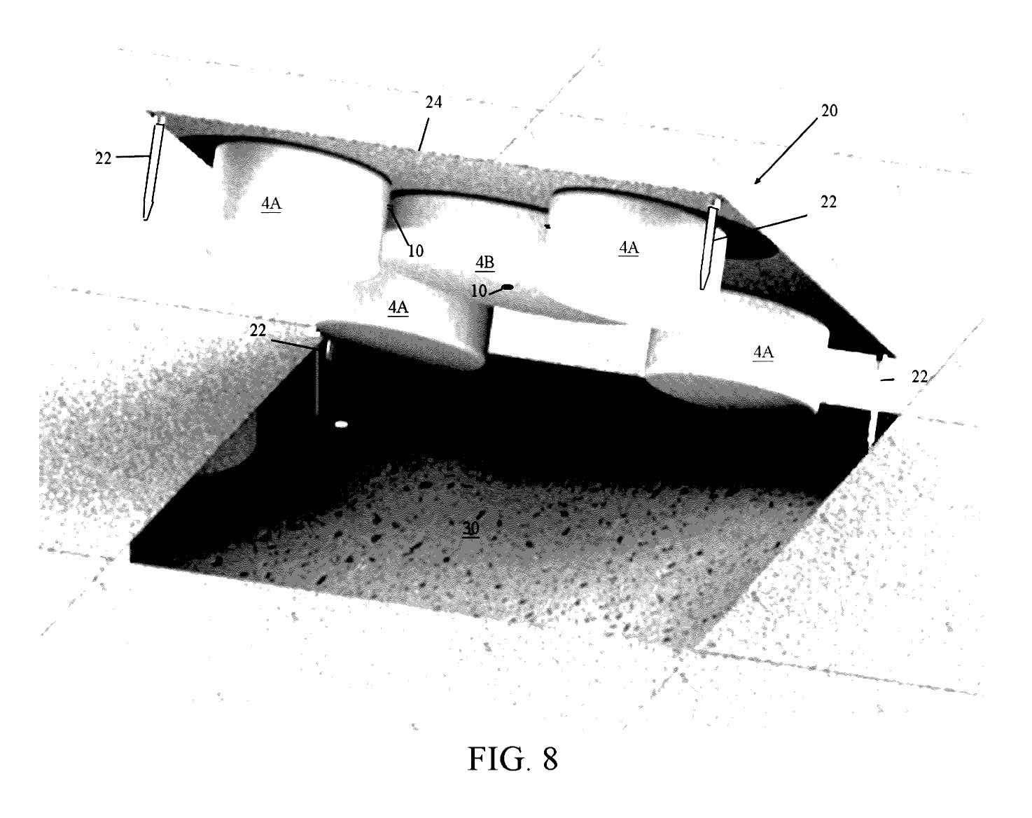

FIG. 8 is a close-up perspective view of an energy absorbing flooring unit 20 raised to show its assembly. Preferably, each tiled energy absorbing flooring unit 20 comprises a lightweight and easily maneuverable tile of nominally 4 square feet (2 ft×2 ft). Tiles 20 may be fastened adjacent to one another to a subfloor framework which may be an existing floor in a retrofit case), and seam molding is utilized to fill the space between tiles 20 to yield a seemingly continuous floor. Each tiled energy absorbing flooring unit 20 further comprises a square floor panel 24 having four (4) corner-mounted centering pins 22 projecting vertically downward at the corners for insertion in spaced receptacles 33 formed in the subfloor 30. A valve 10/chamber 4 arrangement is attached beneath the floor panel 24 as per FIG. 2 or 3, in this case four primary chambers 4A and one central secondary chamber 4B. Similar to FIGS. 2-3, one or more valves 10 are installed, in this case all leading to ambient (or alternatively as in FIG. 2 the primary chambers 4A may vent the fluid into the secondary chambers 4B, which, in turn vent to ambient). The primary chambers 4A are pre-inflated to pressure greater than ambient and below the threshold of the first valve 10. The primary advantage to this tiled approach is that each energy absorbing flooring unit 20 can be independently tuned for the mass that it is supporting (as shown in FIG. 1) without any sacrifice in performance. Another benefit of this configuration is that, while the subfloor 30 may deform as a result of the blast, the independently tunable and independently venting energy absorbing flooring unit 20 will minimize deformation and resulting loads on the floor panels 24 (or top plate 8 shown in FIG. 2 and FIG. 7), which is the interface with the occupant. Yet a third set of advantages to this tiled approach are the clear benefits with respect to installation and maintenance—an oft overlooked, yet critical design aspect. As shown in FIG. 8, each tiled energy absorbing flooring unit 20 weighs approximately 5 pounds and four fasteners are required per unit, thus the modular system of FIGS. 7-8 is easily installed, maintained, replaced, and/or reconfigured. In the embodiment of FIGS. 7-8 both the primary chambers 4A and the secondary chamber 4B are formed as short cylindrical segments having a height and a radius. The height of the secondary chamber 4B is less than the primary chambers 4A. This way, the primary chambers 4A bear the brunt of the impact force during a loading event and the secondary chamber 4B provides supplementary force at a desirable point (determined by the differential in height) within the loading event. The radius of the secondary chamber 4B may be more than the primary chambers 4A. This way, the volume of the primary chambers 4A is less than the secondary chamber 4B which in combination with the corner mounted array primary chambers 4A keep the tiled energy absorbing flooring unit 20 centered during the loading event.

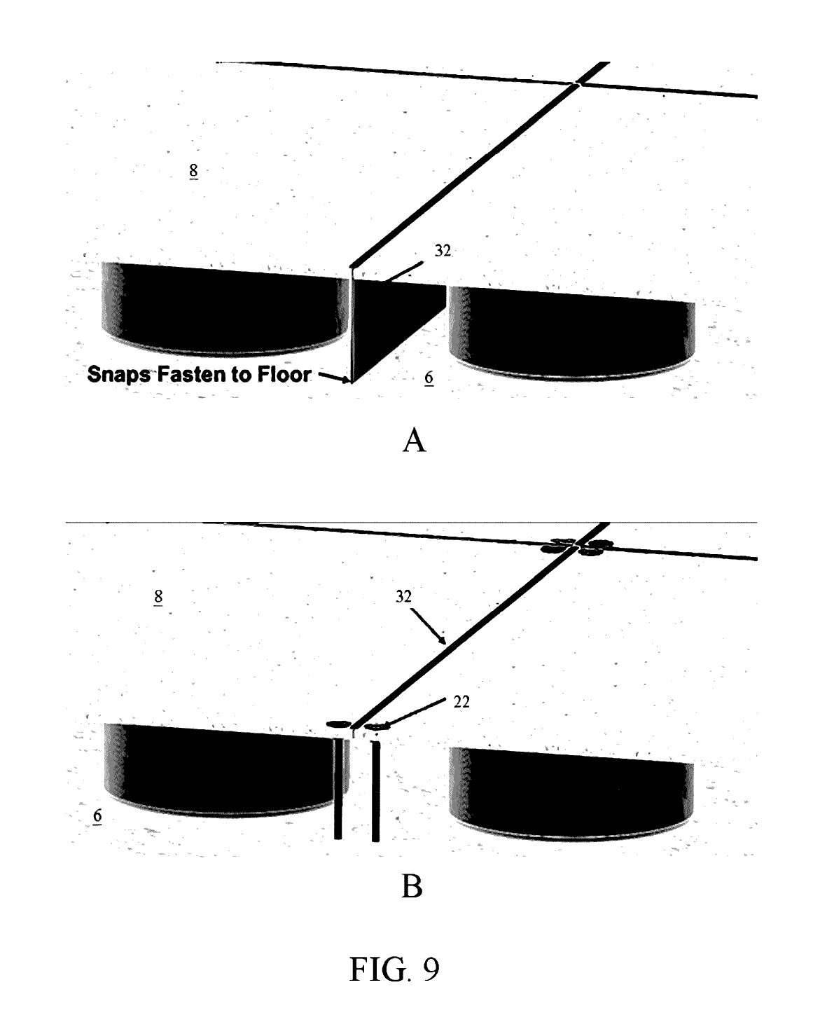

FIG. 9 shows two options for mechanically constraining the payload interface 8 with respect to the base 6 in at least one degree of freedom. At FIG. 9A, each energy absorbing flooring unit 20 is journalled between crossed partitions 32. The partitions are attached to the base 6 but provide just enough clearance for vertical freedom of top plate 8, thereby providing lateral constraint while allowing vertical stroke. FIG. 9 at (B) depicts how the pins 22 are spaced on opposing sides of seam molding 36 to affix adjacent tile energy absorbing flooring units 20.

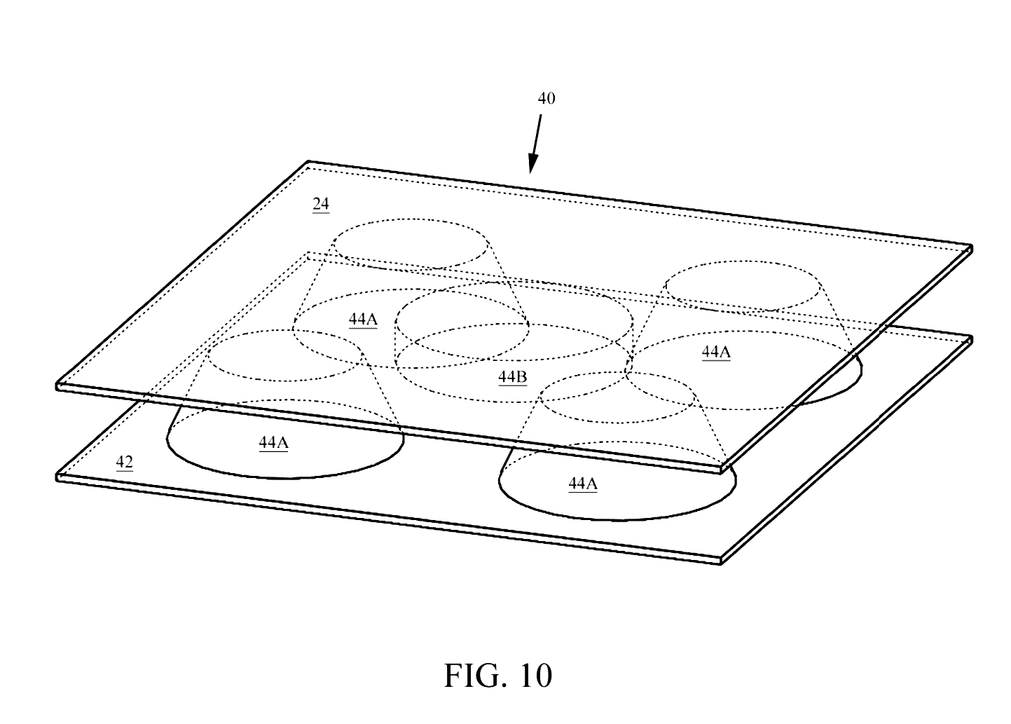

FIG. 10 shows another embodiment of a tiled energy absorbing flooring unit 40 similar to that of FIG. 8 except that the four primary chambers 44A are tapered. Each tiled energy absorbing flooring unit 40 again comprises a lightweight and easily maneuverable tile of nominally 4 square feet (2 ft×2 ft). Tiles 40 may be fastened adjacent to one another to a subfloor framework which may be an existing floor in a retrofit case), and seam molded as above. Each tiled energy absorbing flooring unit 40 further comprises a square floor panel 24 and a like bottom panel 42. Similar to FIGS. 2-3, one or more valves 10 (not shown) may be installed, in this case all leading to ambient (or alternatively as in FIG. 2 the primary chambers 4A may vent the fluid into the secondary chambers 4B, which, in turn vent to ambient). By tapering the four primary chambers 44A the cross-sectional area of chambers 44A increases from top to bottom, resulting in an increasing load-stroke profile. This is because the force exerted on the top plate 24 from each chamber 44A is equal to pressure times area of the chamber 44A. Thus, an increase in area will increase the force exerted on the top plate 24 from each chamber 44A. As such, as the system strokes, the top plate 24 compresses the chambers 44A as it moves closer to the bottom plate 42. As the area increases (or decreases) the force will increase (or decrease) proportionally, thereby creating an increasing or decreasing load-stroke profile. In the illustrated embodiment all four primary chambers 44A are tapered upward in a frusto-conical shape which results in a convenient volume calculation as follows:

$$V = \frac{{h}_{1} {B}_{1} - {h}_{2} {B}_{2}}{3}$$

where B₁ is the area of one base, B₂ is the area of the other base, and h₁, h₂ are the perpendicular heights from the apex to the planes of the two bases. As the bases are compressed together B₁ expands, B₂ stays constant, and h₁, h₂ contract, decreasing the force on plate 24 proportionally. One skilled in the art will readily understand that the frusto-conical chambers 44A may be inverted for the opposite effect, and different shapes may be used.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. One skilled in the art should understand that design parameters such as fluid vent area, inflation pressure, and trigger parameter (a pre-determined threshold for said dynamic parameter), may be tailored for a particular loading event or particular payload mass. These parameters may be: 1) automatically pre-set based upon a priori measurements (i.e. inflation pressure, vent area); and/or 2) automatically adjusted by the controller based on measured payload mass); and/or 3) automatically adjusted in real-time during an actual impact event. Further, systems may be positioned adjacently to give the appearance of a continuous payload interface as shown in FIG. 7-9, whereby individual systems may be independently tailored using aforementioned design parameters to tailor the individual system for the payload that it supports.

The payload interface (top plate) may be mechanically constrained in one or more degrees of freedom while allowing stroking in one or more desired directions. This may be accomplished in a variety of manners available to those skilled in the art, including but not limited to linear bearings, sliders, pivots, bolts in clearance holes, etc.

The cross sectional area of the fluid chambers may be designed to vary along the direction of desired stroke in order to tailor a desired load-stroke profile. For example, the cross sectional area is held constant along the stroking direction in all the foregoing embodiments to provide a substantially constant load-stroke profile.

It is to be understood, therefore, that the invention may be practiced otherwise than as specifically set forth in the appended claims.

We claim:

1. A protective flooring system, comprising:
a first plate;
a second plate;
a plurality of flexible chambers sandwiched between said first plate and said second plate, each of said chambers being configured to be filled with a fluid;
at least one release valve in fluid communication with each of said plurality of flexible chambers containing an orifice for venting fluid therefrom.

2. The protective flooring system of claim 1, wherein said orifice is sized to provide a desired response when fluid is vented.

3. The protective flooring system of claim 1, wherein said at least one valve comprises any one or more from among the group consisting of a flow regulator valve, a bypass flow regulator; a demand-compensated flow control valve; a pressure-compensated variable flow valve; a pressure-and temperature-compensated, variable flow-control valve; a priority valve; and a deceleration valve.

4. The protective flooring system of claim 1, wherein said plurality of flexible chambers further comprises at least one primary chamber, and at least one secondary chamber whereby the secondary chamber supplements the primary chamber.

5. The protective flooring system of claim 1, wherein at least one of said plurality of flexible chambers is in fluid-communication with a regulated fluid supply to maintain a constant pressure.

6. The protective flooring system of claim 4, wherein said at least one release valve further comprises a first release valve in fluid communication with both of said primary and secondary chambers for venting fluid from said primary chamber to said secondary chamber, and a second release valve from said secondary chamber to ambient for venting fluid therefrom.

7. The protective flooring system of claim 4, further comprising a source of fluid in fluid communication with one or both of said primary chamber and said secondary chamber.

8. The protective flooring system of claim 4, wherein said at least one release valve further comprises a first release valve in fluid communication between said primary chamber and ambient, and a secondary release valve in fluid communication from said secondary chamber to ambient for venting fluid therefrom.

9. The protective flooring system of claim 4, wherein said primary chambers are pre-pressurized to above ambient and said secondary chambers are open to ambient via at least one orifice.

10. The protective flooring system of claim 9, wherein said orifice is sized to yield a predetermined pressure response when compressed.

11. The protective flooring system of claim 4, wherein said secondary chamber does not vent.

12. The protective flooring system of claim 1, wherein said release valve opens when a dynamic parameter from among the group consisting of pressure, displacement, acceleration, velocity, time, rotation, force, or moment, exceeds a threshold for said dynamic parameter.

13. The protective flooring system of claim 12, wherein said threshold is pre-determined.

14. The protective flooring system of claim 12, further comprising at least one sensor measuring at least one said dynamic parameter.

15. The protective flooring system of claim 14, wherein said at least one sensor comprises any one or more from among the group consisting of an accelerometer, a break wire sensor, a displacement sensor, a pressure sensor, and a load sensor.

16. The protective flooring system of claim 14, wherein said threshold is adjusted based upon measurement by said at least one sensor.

17. The protective flooring system of claim 14, further comprising an electrically adjustable orifice to adjust the flow of said fluid.

18. The protective flooring system of claim 17, wherein electrically adjustable orifice is actuated by a solenoid.

19. The protective flooring system of claim 17, wherein said electrically adjustable orifice is adjusted based upon measurement from said at least one sensor.

20. The protective flooring system of claim 1, wherein each of said plurality of flexible chambers is configured to vent independently of all other flexible chambers.

21. A protective flooring system, comprising:
a subfloor;
a plurality of modular floor tiles installed in said subfloor framework, each said tile comprising. a top plate;
a plurality of flexible chambers attached beneath said top plate;
at least one release valve in fluid communication with each of said plurality of flexible chambers for venting fluid therefrom.

22. The protective flooring system of claim 21, wherein said plurality of flexible chambers further comprises at least one primary chamber and at least one secondary chamber.

23. The protective flooring system of claim 22, wherein said plurality of flexible chambers further comprise four primary chambers and one secondary chamber.

24. The protective flooring system of claim 22 wherein said secondary chamber is attached to said top in a center of said four primary chambers.

25. The protective flooring system of claim 22, wherein said primary chambers and said secondary chamber are formed as segments each having a height in a direction orthogonal to said top plate and a diameter.

26. The protective flooring system of claim 25, wherein the height of said primary chambers is greater than the height of said secondary chambers.

27. The protective flooring system of claim 25, wherein at least one of said primary chambers and said secondary chamber are formed as a conical segment having a height in a direction orthogonal to said top plate and a tapering diameter.

28. The protective flooring system of claim 22, wherein the height of said primary chambers is greater than a height of said secondary chamber.

29. The protective flooring system of claim 21, wherein each of said modular floor tiles is tuned and acts independent of all other of said modular floor tiles.

30. The protective flooring system of claim 21, wherein said release valve opens when a dynamic parameter from among the group consisting of pressure, displacement, acceleration, velocity, time, rotation, force, or moment, exceeds a threshold for said dynamic parameter.

31. The protective flooring system of claim 21, wherein each of said plurality of flexible chambers is configured to vent independently of all other flexible chambers.
